(19) United States
(12) Patent Application Publication
(10) Pub. No.: US 2011/0096090 A1
(43) Pub. Date: Apr. 28, 2011

(54) DISPLAY DEVICE AND METHOD FOR ANIMATING AN ON-SCREEN DISPLAY MENU

(75) Inventor: TSANG-HSING LEE, TAIPEI (TW)

(73) Assignee: WISTRON CORPORATION, TAIPEI (TW)

(21) Appl. No.: 12/912,423

(22) Filed: Oct. 26, 2010

(30) Foreign Application Priority Data
Oct. 28, 2009 (TW) 098136474

(51) Int. Cl. G09G 5/00; G09G 5/36

(52) U.S. Cl. 345/629; 345/545

(57) ABSTRACT

A display device includes: a first memory for storing OSD animation program instructions and an original OSD menu frame; a microcontroller for executing the OSD animation program instructions so as to generate (N) covering frames that are superimposed on (N) copies of the original OSD menu frame in order to generate (N) partially covered OSD menu frames, and outputting sequentially the (N) partially covered OSD menu frames and the original OSD menu frame to a second memory in response to receipt of a command for opening an OSD menu; and an image output unit for sequentially and continuously reading the (N) partially covered OSD menu frames and the original OSD menu screen from the second memory and outputting sequentially and continuously the (N) partially covered OSD menu frames and the original OSD menu frame to the display unit for display, thus effecting animation of the OSD menu.

### CROSS-REFERENCE TO RELATED APPLICATION

This application claims priority of Taiwanese application no. 098136474, filed on Oct. 28, 2009.

### BACKGROUND OF THE INVENTION

1. Field of the Invention

This invention relates to a method for displaying an on-screen display menu, more particularly to a method for animating an on-screen display menu.

2. Description of the Related Art

The on-screen display (OSD) menu of a conventional display device, such as that of a television or a computer, is typically static. In other words, when a user presses a button of a television remote controller or computer monitor for opening the OSD menu, the conventional display device directly displays an OSD menu frame. This manner of displaying the OSD menu is monotonous and fails to interest the user.

Therefore, animating the OSD menu would be appealing to the user and add value to the conventional display device.

### SUMMARY OF THE INVENTION

Therefore, an object of the present invention is to provide a display device that uses a plurality of static image frames to animate an on-screen display (OSD) menu.

According to the present invention, there is provided a display device comprising a display unit, first and second memories, a microcontroller, and an image output unit.

The first memory is for storing an original on-screen display (OSD) menu frame. The second memory is for storing image frames to be outputted to the display unit. The microcontroller is capable of accessing the first and second memories, for executing, upon receipt of a command for opening an OSD menu, (N) loops, wherein (N) is a non-zero positive integer, and wherein the microcontroller obtains (N) copies of the original OSD menu frame, generates (N) covering frames that have progressively reduced covering areas, superimposes the (N) covering frames respectively on the (N) copies of the original OSD menu frame in order to generate sequentially (N) partially covered OSD menu frames, and outputs sequentially the (N) partially covered OSD menu frames to the second memory, and for outputting the original OSD menu screen to the second memory upon terminating an (Nth) loop. The image output unit is electrically coupled to the display unit and the second memory for sequentially and continuously reading the (N) partially covered OSD menu frames and the original OSD menu frame from the second memory and outputting sequentially and continuously the (N) partially covered OSD menu frames and the original OSD menu frame to the display unit for display.

This invention animates the OSD menu by displaying sequentially and continuously, at a same site on a display of the display unit, a plurality of partially covered OSD menu frames, each being a static image frame that is distinct from a next one of the image frames, and the original OSD menu frame.

According to another aspect of the present invention, there is provided a display device comprising a display unit, first and second memories, a microcontroller, and an image output unit.

The first memory is for storing a plurality of on-screen display (OSD) frames and an original OSD menu frame, each of the OSD frames including an image of an object such that when the OSD frames are displayed sequentially, a visual effect is generated in which the object appears to move continuously. The second memory is for storing image frames to be outputted to the display unit. The microcontroller is capable of accessing the first and second memories, for reading sequentially the OSD frames and the original OSD frame from the first memory and outputting sequentially the OSD frames and the original OSD menu frame to the second memory in response to a command for opening an OSD menu. The image output unit is electrically coupled to the display unit and the second memory for reading sequentially and continuously the OSD frames and the original OSD frame from the second memory and outputting the OSD menu frames and the original OSD frame to the display unit for display, thus effecting animation of the OSD menu.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic circuit block diagram of a first preferred embodiment of a display device according to the present invention;

FIG. 2 is a flowchart to illustrate setting of a desired on-screen display (OSD) menu animation type and activation of the corresponding OSD menu animation;

FIG. 3 is a flowchart to illustrate a first preferred embodiment of the method for animating an OSD menu according to the present invention, in which a “blinds” animation of the OSD menu is produced;

FIG. 4 is a sequence diagram for illustrating sequential generation and display of static image frames prior to display of an original OSD menu frame for producing the “blinds” animation;

FIG. 5 is a flowchart to illustrate the first preferred embodiment, in which a “mosaic” animation of the OSD menu is produced;

FIG. 6 is a sequence diagram for illustrating sequential generation and display of static image frames prior to display of the original OSD menu frame for producing the “mosaic” animation; and

FIG. 7 is a sequence diagram to illustrate a second preferred embodiment of the method for animating the OSD menu according to the present invention, in which static OSD frames are sequentially displayed prior to display of the original OSD menu frame.

### DETAILED DESCRIPTION OF THE PREFERRED EMBODIMENTS

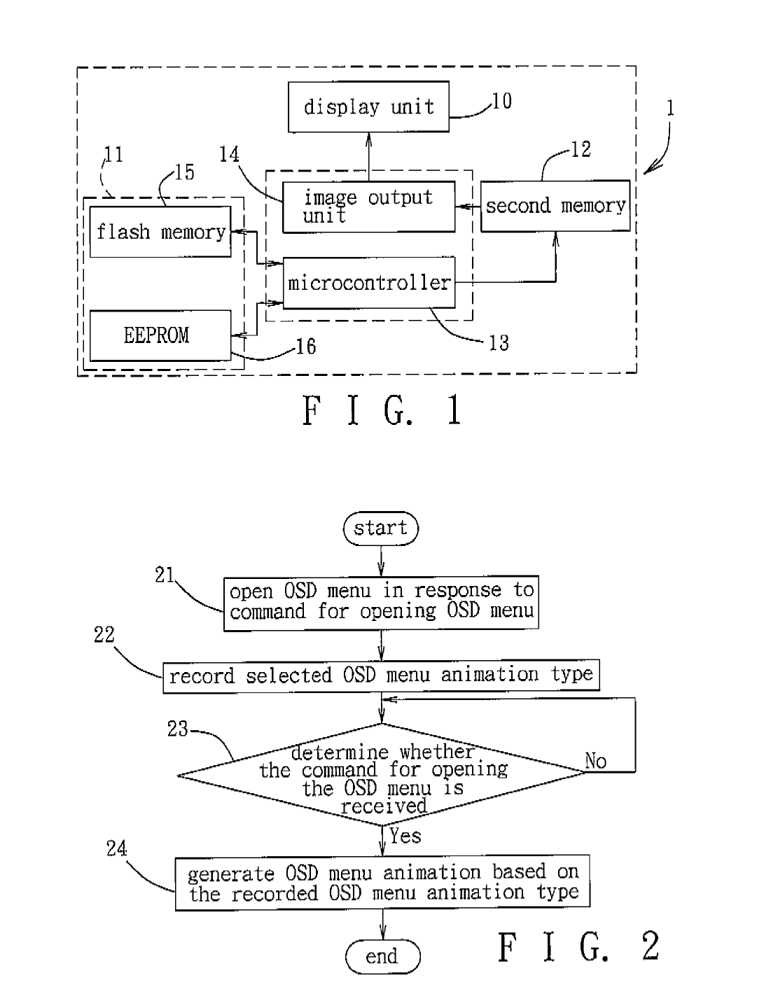

FIG. 1 illustrates a first preferred embodiment of a display device 1 according to the present invention. The display device 1 can be a television display, or a monitor or display of a conventional computer or electronic device that outputs image signals and has either a flat panel or non-flat panel, such display devices typically having an on-screen display (OSD) menu function, and accepting control from a user for opening an OSD menu. Through the OSD menu, the user can set internal functions and parameters of the display device 1.

The display device 1 comprises a display unit 10, first and second memories 11,12, a microcontroller 13, and an image output unit 14. The display unit 10 can be one that utilizes liquid crystal, plasma, light emitting diode, or cathode ray tube (CRT) technologies. The first memory 11 is for storing an original OSD menu frame. The second memory 12 is for storing image frames to be outputted to the display unit 10. The microcontroller 13 is capable of accessing the first and second memories 11,12 for generating and outputting the image frames. The image output unit 19 is electrically coupled to the second memory 12 and the display unit 10 for outputting the image frames from the second memory 12 to the display unit 10 for display.

In this embodiment, the first memory 11 is a read-only memory, and includes a flash memory 15 for storing OSD animation program instructions i.e., firmware, and an electrically erasable programmable read-only memory (EEPROM) 16 for storing the original OSD menu frame. The second memory 12 is a random access memory (RAM). The image output unit 19 is a scaler (an image frame scaling device) that adjusts a resolution of the image frames to be outputted to the display unit 10 to a resolution the display unit 10 is capable of displaying. The microcontroller 13 and the image output unit 14 are usually integrated in an image-processing chip.

Referring to FIG. 2, in step 21, the microcontroller 13 receives an initial command for opening the OSD menu. In this embodiment, an OSD menu animation option is included in the OSD menu. When the OSD menu animation option is selected, OSD menu animation type options are displayed. In this embodiment, the OSD menu animation types include “blinds” and “mosaic” animations. Each of the OSD menu animation types corresponds to a set of the OSD animation program instructions stored in the flash memory 15.

In step 22, when one of the OSD menu animation types is selected, the microcontroller 13 records the selected OSD menu animation type.

In step 23, the microcontroller 13 determines whether the command for opening the OSD menu option has been received again. When the microcontroller 13 determines that the command has been received, the flow proceeds to step 24.

In step 24, the microcontroller 13, based on the recorded OSD menu animation type, accesses the corresponding set of the OSD animation program instructions from the flash memory 15 and executes this set of program instructions so as to generate a corresponding animation of the OSD menu. A first preferred embodiment of the method for animating an OSD menu according to the present invention, as performed by the microcontroller 13, is detailed below.

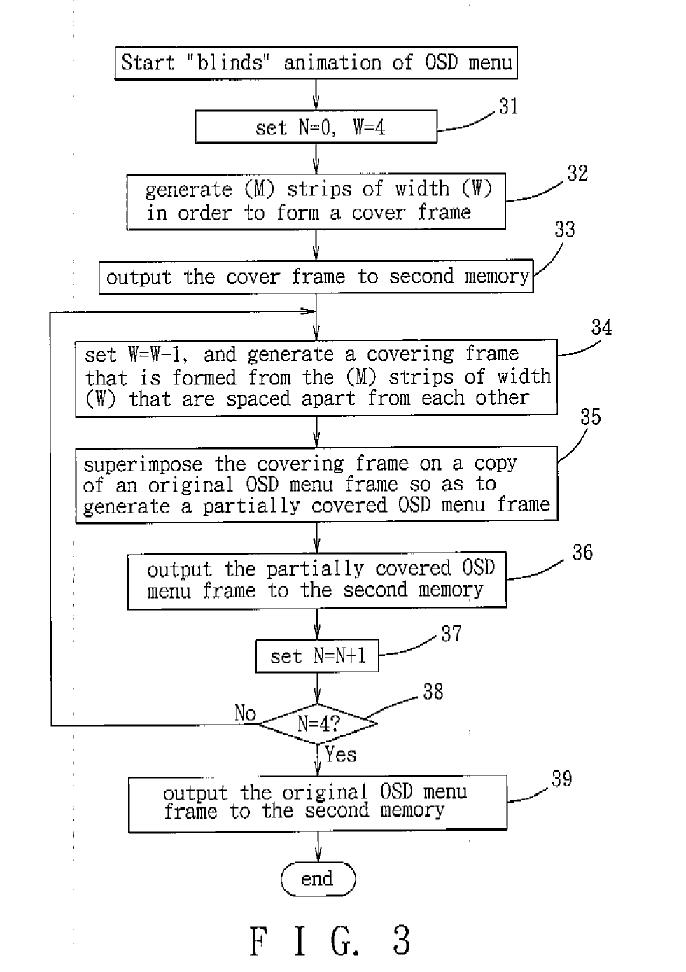

Referring to FIG. 3, when the selected OSD menu animation type is the “blinds” animation, the microcontroller 13 executes the following steps in accordance with the corresponding set of the OSD animation program instructions.

In step 31, the microcontroller 13 sets a total number of static partially covered image frames to be generated to four, and sets an initial value of (N) to zero.

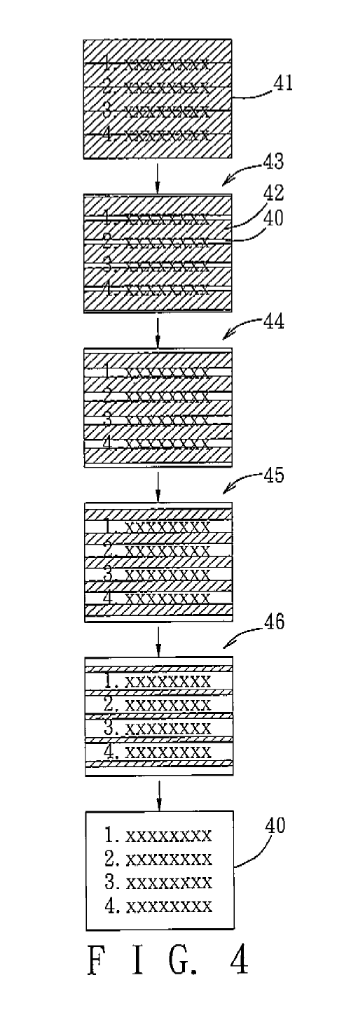

In step 32, the microcontroller 13 preferably first generates a cover frame 41, as shown in FIG. 4. The cover frame 41 has an area identical to an area of the original OSD menu frame 40, and is composed of (M) strips, such as five strips, that are arranged crosswise. Each of the (M) strips of the cover frame 41 has a width (W), such as four centimeters.

In step 33, the microcontroller 13 outputs the cover frame 41 to the second memory 12. The image output unit 14 reads the cover frame 41 from the second memory 12 and outputs the cover frame 41 to the display unit 10 for display. The cover frame 41 can be composed of strips of black, strips of a certain color, or strips of certain colors.

In step 34, the microcontroller 13 sets the width (W) of each of the (M) strips to (W=W−1), so as to generate a first covering frame 42 composed of the (M) strips of width (W) that are spaced apart from each other.

In step 35, the microcontroller 13 obtains a copy of the original OSD menu frame from the EEPROM 16 and superimposes the first covering frame 42 on the copy of the original OSD menu frame 40 so as to generate a first partially covered OSD menu frame 43.

In step 36, the microcontroller 13 outputs the first partially covered OSD menu frame 43 to the second memory 12, and the image output unit 14 reads the first partially covered OSD menu frame 43 from the second memory 12 and outputs the first partially covered OSD menu frame 43 to the display unit 10 for display.

In step 37, the microcontroller 13 sets (N) to (N+1), and in step 38, the microcontroller 13 determines whether (N) is equal to four. When (N) is not equal to four, steps 34 through 38 are repeated. In this case, since (N) is equal to one after a first iteration of steps 34 through 38 in which the first partially covered OSD menu frame 43 is generated and outputted, the microcontroller 13 proceeds to perform three more iterations, in which the microcontroller 13 obtains three copies of the original OSD menu frame 40, generates second through fourth covering frames having progressively reduced covering areas, superimposes the covering frames respectively on the three copies of the original OSD menu frame 40 in order to generate sequentially second through fourth partially covered OSD menu frames 44, 45, 46, and outputs sequentially and continuously the second through the fourth partially covered OSD menu frames 44˜96 to the second memory 12. The image output unit 14 reads sequentially and continuously the partially covered OSD menu frames 94˜96 and outputs sequentially and continuously the partially covered OSD menu frames 44˜46 to the display unit 10 for display.

When it is determined in step 38 that (N) is equal to four, the flow proceeds to step 39, in which the microcontroller 13 outputs the original OSD menu frame 90 to the second memory 12, and the image output unit 14 reads the original OSD menu frame 40 from the second memory 12 and outputs the original OSD menu frame 40 to the display unit 10 for display.

Since the covering frames have progressively reduced covering areas on account of the width (W) of each of the (M) strips that form the covering frames being progressively reduced, and the cover frame 41, the partially covered OSD menu frames 43, 44, 45, 46, and the original OSD menu frame 40 are output to the display unit 10 sequentially and continuously, the OSD menu is animated such that content of the original OSD menu frame 40 is revealed gradually.

Clearly, steps 32 and 33 can be omitted, and step 34 can be performed directly following step 31 without affecting animation of the OSD menu.

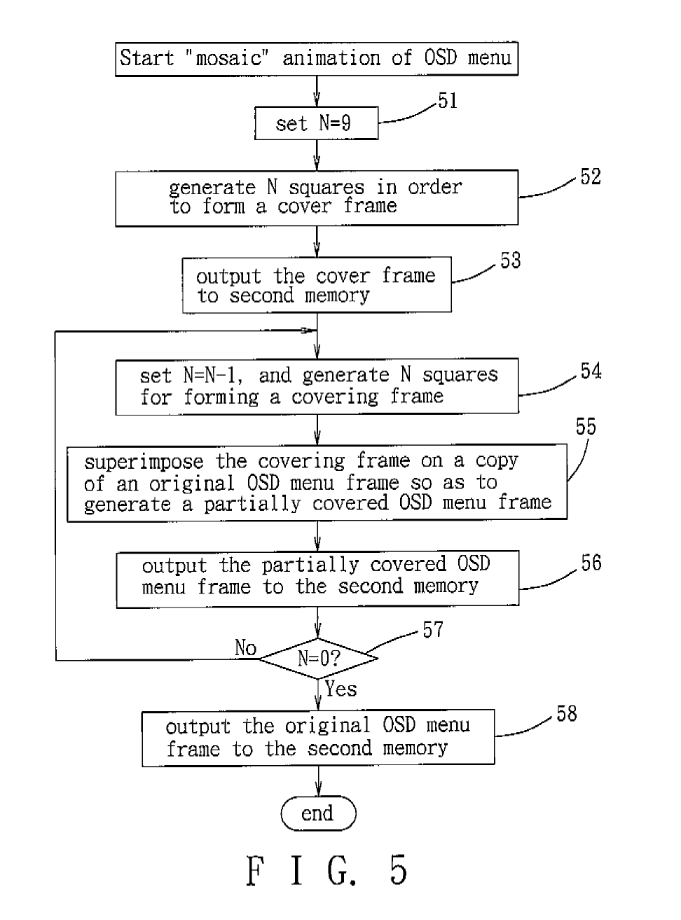

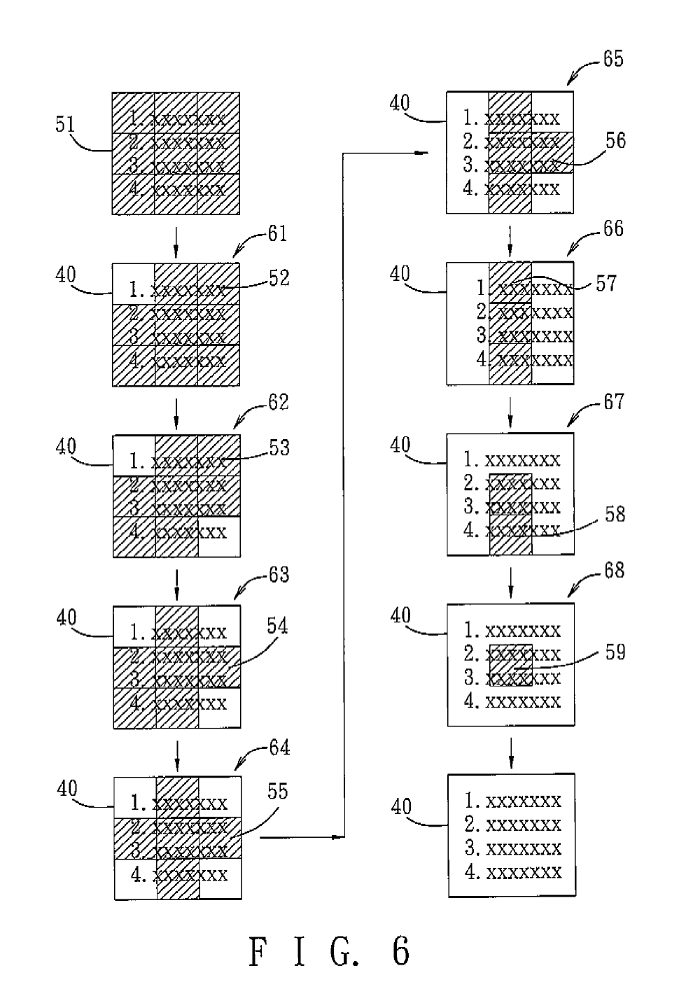

Referring to FIGS. 5 and 6, when the selected OSD menu animation type is the “mosaic” animation, the microcontroller 13 executes the following steps according to the corresponding set of the OSD animation program instructions.

In step 51, referring to FIG. 5, the microcontroller 13 sets the total number of static image frames to be generated (N) to nine.

In step 52, the microcontroller 13 generates (N) squares (the number of squares is equal to the number of static image frames to be generated) and arranges the (N) squares in a matrix so as to form the cover frame 51 having the area identical to the area of the original OSD menu frame 40.

In step 53, the microcontroller 13 outputs the cover frame 51 to the second memory 12. The image output unit 14 then reads the cover frame 51 from the second memory 12 and outputs the cover frame 51 to the display unit 10 for display. The cover frame 51 can be composed of black squares, or squares of a certain color, or squares of certain colors.

In step 54, the microcontroller 13 sets (N) to (N−1), and generates (N) (N=8) squares so as to form the first covering frame 52.

In step 55, the microcontroller 13 obtains a copy of the original OSD menu frame 40 from the EEPROM 16 and superimposes the first covering frame 52 on the original OSD menu frame 40 so as to generate the first partially covered OSD menu frame 61 and outputs the first partially covered OSD menu frame 61 to the second memory 12. The image output unit 14 then reads the first partially covered OSD menu frame 61 and outputs the first partially covered OSD menu frame 61 to the display unit 10 for display.

In step 57, it is determined whether (N) is equal to zero. When it is determined that (N) is not equal to zero, steps 54 through 57 are repeated. In this case, since (N) is equal to eight after a first iteration of steps 54 through 57 in which the first partially covered OSD menu frame 61 is generated and outputted, the microcontroller 13 proceeds to perform seven more iterations, in which the microcontroller 13 obtains seven copies of the original OSD menu frame 40, generates the second through eighth covering frames 53, 54, 55, 56, 57, 58, 59 having progressively reduced covering areas, superimposes the covering frames 53˜59 respectively on the seven copies of the original OSD menu frame 40 in order to generate sequentially the second through the eighth partially covered OSD menu frames 62, 63, 64, 65, 66, 67, 68, and outputs sequentially the second through the eighth partially covered OSD menu frames 62˜68 to the second memory 12. The image output unit 14 then reads sequentially and continuously the partially covered OSD menu frames 62˜68 and outputs sequentially and continuously the partially covered OSD menu frames 62˜68 to the display unit 10 for display.

When it is determined in step 57 that (N) is equal to zero, the flow proceeds to step 58, in which the microcontroller 13 outputs the original OSD menu frame 40 to the second memory 12, and the image output unit 14 reads the original OSD menu frame 40 from the second memory 12 and outputs the original OSD menu frame 40 to the display unit 10 for display.

Since the number of the squares forming the covering frames 52˜59 that are superimposed respectively on the copies of the original OSD menu frame 40 is progressively reduced, and since the cover frame 51, the partially covered OSD menu frames 61˜68, and the original OSD menu frame 40 are output to the display unit 10 sequentially and continuously, the OSD menu is animated such that the content of the original OSD menu frame 40 is revealed gradually.

Clearly, steps 52 and 53 can be omitted, and step 54 can be performed directly following step 51 without affecting animation of the OSD menu.

Although strips and squares are the elements used for composing the cover frame 41,51 and the covering frames 42, 52˜59 in this embodiment, this invention is not limited to such. It is only necessary that the elements be configurable such that the covering frames 42, 52˜59 have covering areas that are progressively reduced, so that when the partially covered OSD menu frames 43˜46, 61˜68 are displayed sequentially and continuously, the content of the original OSD menu frame 40 is revealed gradually.

In summary, the present invention, through displaying sequentially and continuously, at a same site on a display of the display unit, a plurality of static image frames, that is, the copies of the original OSD menu frames that are partially and respectively covered by the covering frames 42, 52˜59 having progressively reduced covering areas, and the original OSD menu frame 40, generates a visual effect in which the content of the original OSD menu frame 40 is gradually revealed. This invention thus effectively uses a plurality of static image frames to animate the OSD menu.

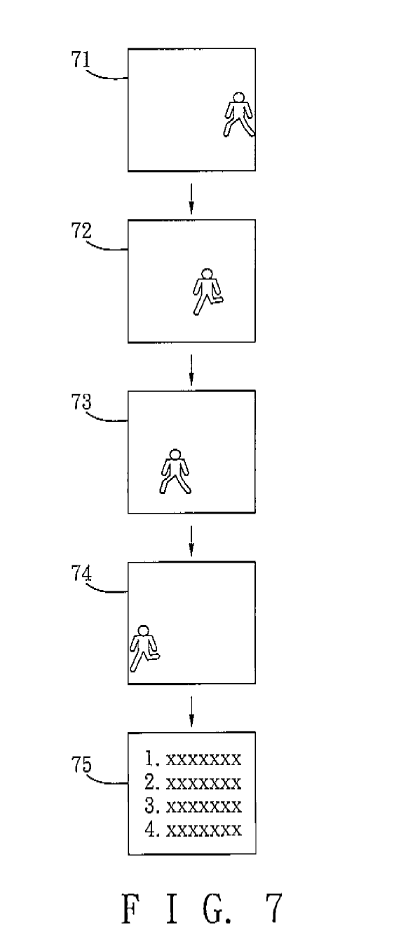

FIG. 7 illustrates the second preferred embodiment of the method for animating an OSD menu according to the present invention. The second preferred embodiment has in common with the first preferred embodiment the display device 1 having the display unit 10, the first memory 11, the second memory 12, the microcontroller 13, and the image output unit 14, as shown in FIG. 1. The second preferred embodiment differs from the first preferred embodiment in that the first memory 11 stores a plurality of OSD frames 71, 72, 73, 74 and the original OSD menu frame 75, an area of each of the OSD frames 71˜74 being identical to the area of the original OSD menu frame 75. Each of the OSD frames 71˜74 includes an image of an object (in this case, a man), such that when the OSD frames 71˜74 are displayed sequentially and continuously, a visual effect is generated in which the object appears to move continuously (in this case, to walk).

The microcontroller 13 is capable of accessing the first and second memories 11,12, for reading sequentially the OSD frames 71˜74 and the original OSD frame 75 from the first memory 11 and outputting sequentially the OSD frames 71˜74 and the original OSD menu frame 75 to the second memory 12 in response to the command for opening the OSD menu. The image output unit 14 reads sequentially and continuously the OSD frames 71˜74 and the original OSD frame 75 from the second memory 12 and outputs the OSD menu frames 71˜74 and the original OSD frame 75 to the display unit 10 for display, generating the visual effect of the man walking, perhaps walking from a center of a screen of the display unit 10 to the left or right, prior to displaying the original OSD menu frame 75, thus effecting animation of the OSD menu.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A display device comprising:
a display unit;
a first memory for storing an original on-screen display (OSD) menu frame;
a second memory for storing image frames to be outputted to said display unit;
a microcontroller capable of accessing said first and second memories, for
executing, upon receipt of a command for opening an OSD menu, (N) loops, wherein (N) is a non-zero positive integer, and wherein said microcontroller obtains (N) copies of said original OSD menu frame, generates (N) covering frames that have progressively reduced covering areas, superimposes said (N)covering frames respectively on said (N) copies of said original OSD menu frame in order to generate sequentially (N) partially covered OSD menu frames, and outputs sequentially said (N) partially covered OSD menu frames to said second memory, and
outputting said original OSD menu screen to said second memory upon terminating an (Nth) loop; and
an image output unit electrically coupled to said display unit and said second memory for sequentially and continuously reading said (N) partially covered OSD menu frames and said original OSD menu frame from said second memory and outputting sequentially and continuously said (N) partially covered OSD menu frames and said original OSD menu frame to said display unit for display.

2. The display device as claimed in claim 1, wherein said microcontroller, before executing the (N) loops, generates a cover frame having an area identical to an area of said original OSD menu frame, and outputs said cover frame to said second memory.

3. The display device as claimed in claim 1, wherein: said first memory is a read-only memory, and includes a flash memory for storing OSD animation program instructions, and an electrically erasable programmable read-only memory (EEPROM) for storing said original OSD menu frame; and said microcontroller executes said OSD animation program instructions for sequentially generating said (N) partially covered OSD menu frames, and sequentially outputting said (N) partially covered OSD menu frames and said original OSD menu frame to said second memory.

4. A method for animating an on-screen display (OSD) menu, adapted to be performed by a display device having an original OSD menu frame stored therein, said method for animating an OSD menu comprising the steps of:
(A) configuring a microcontroller of the display device to execute, upon receipt of a command for opening the OSD menu, (N) loops, wherein (N) is a non-zero positive integer, and wherein said microcontroller obtains (N) copies of the original OSD menu frame, generates (N) covering frames that have progressively reduced covering areas, superimposes the (N)covering frames respectively on the (N) copies of the original OSD menu frame in order to generate sequentially (N) partially covered OSD menu frames, and outputs sequentially the (N) partially covered OSD menu frames to a second memory of the display device, and
to output said original OSD menu frame to the second memory upon terminating the (Nth) loop; and
(B) configuring an image output unit of the display device to read sequentially and continuously the (N) partially covered OSD menu frames and the original OSD menu frame from the second memory and to output sequentially and continuously the (N) partially covered OSD menu frames and the original OSD menu frame to a display unit of the display device for display.

5. The method for animating an OSD menu as claimed in claim 4, wherein, in step (A), the microcontroller is configured to generate, before executing the (N) loops, a cover frame having an area identical to an area of the original OSD menu frame and to output the cover frame to the second memory, so that in step (B), the image output unit reads the cover frame and outputs the cover frame to the display unit prior to reading and outputting to the display unit the (N) partially covered OSD menu frames.

6. A display device comprising:
a display unit;
a first memory for storing a plurality of on-screen display (OSD) frames and an original OSD menu frame, each of said OSD frames including an image of an object such that when said OSD frames are displayed sequentially, a visual effect is generated in which the object appears to move continuously;
a second memory for storing image frames to be outputted to said display unit;
a microcontroller capable of accessing said first and second memories, for reading sequentially said OSD frames and said original OSD frame from said first memory and outputting sequentially said OSD frames and said original OSD menu frame to said second memory in response to a command for opening an OSD menu; and
an image output unit electrically coupled to said display unit and said second memory for reading sequentially and continuously said OSD frames and said original OSD menu frame from said second memory and outputting said OSD frames and said original OSD menu frame to said display unit for display.

7. The display device as claimed in claim 6, wherein said first memory is a read-only memory including a flash memory and an electrically erasable programmable read-only memory (EEPROM), said flash memory storing said OSD frames, said EEPROM storing said original OSD menu frame.

8. A method for animating an on-screen display (OSD) menu adapted for a display device, said method for animating an OSD menu comprising the steps of:
(A) storing a plurality of OSD frames and an original OSD menu frame in a first memory of the display device, each of the OSD menu frames including an image of an object such that when the OSD frames are displayed sequentially, a visual effect is generated in which the object appears to move continuously;
(B) configuring a microcontroller of the display device to read sequentially the OSD frames and the original OSD menu frame from the first memory, and to output sequentially the OSD frames and the original OSD menu frame to a second memory of the display device in response to a command for opening an OSD menu; and
(C) configuring an image output unit of the display device to read sequentially and continuously the OSD frames and the original OSD menu frame from the second memory and to output the OSD frames and the original OSD menu frame to a display unit of the display device for display.
